(19) United States
(12) Patent Application Publication
(10) Pub. No.: US 2012/0290907 A1
(43) Pub. Date: Nov. 15, 2012

(54) METHOD AND SYSTEM FOR ASSOCIATING SYNCHRONIZED MEDIA BY CREATING A DATAPOD

(75) Inventors: Ross Quentin Smith, Palo Alto, CA (US); Miriam Barbara Sedman, Palo Alto, CA (US); Joan Lorraine Wood, San Jose, CA (US)

(73) Assignee: JIGSAW INFORMATICS, INC., Palo Alto, CA (US)

(21) Appl. No.: 13/553,529

(22) Filed: Jul. 19, 2012

(51) Int. Cl. G06F 17/00

(52) U.S. Cl. 715/203

(57) ABSTRACT

The present invention relates to a system and method for creating a Datapod™ that includes the synchronized association of media and data objects. One embodiment of the present invention involves creating a Datapod™ by acquiring a media object, annotating the media object with a data object, and associating the media object with the data object to form an ordered or synchronized relationship between the media object and data object which implicitly defines a visual/auditory or similar experiential connection. The present invention also provides its functionality with an easy to use user interface that enables the user to readily create the synchronous association and to share the resulting Datapod™ with the intended audience.

### BACKGROUND

A. Technical Field

This invention relates generally to software applications for mobile and other devices, and more particularly to creating and maintaining a synchronized association of objects when displayed on any device, including mobile devices, personal computers (PCs), game systems, automotive and avionics displays, digital picture frames, TVs, set top boxes, digital video and still cameras, smart office and home appliances and lab or industrial devices equipped with displays and audio/visual capabilities, wearable computers, etc.

B. Background of the Invention

Communicating using combinations of various file types, for example, audio, video, photo, image, and text files poses some challenges. One challenge is maintaining a proper sequence or synchronization of the files. If a sender using a mobile device desires to communicate a photo and annotate the photo by way of an audio description, the sender is forced to send two separate files. Those two files (photo and audio description) then have no association with each other and the recipient may or may not play them in the correct sequence required to recreate the sender's intended message. In order for the sender to ensure the recipient played the appropriate files in the right sequence and with the right synchronization, the sender would also have to send a detailed set of instructions and rely on the recipient to follow them.

Furthermore, the sender may also wish to communicate particular “navigation” information associated with one or more files. For example, the sender may wish to zoom in on or highlight a particular part of the photo to call the recipient's attention to it. This information would also be lost in the communication of the two files unless the sender took yet another photo of the zoomed in or highlighted portion and communicated the details about the zoomed or highlighted image.

The above problems are compounded when the sender is sending not just two files, but many more. If the sender is communicating a large amount of data or many different images, videos, audio recordings or text files, the recipient would most certainly be confused and lost trying to piece together the various files in the proper order and with the proper annotations.

The above problems are further compounded when the sender is sending the files from a mobile device such as a smart phone or tablet where the limitations of the screen size and, in many cases, limitations associated with only having a touch screen as an input device requires a vastly simplified user interface compared to conventional PCs.

In summary, what is needed is an intuitive, simple and user friendly way of associating media objects on a mobile device, and preserving that association when the media objects are communicated to and played on other devices including mobile devices, personal computers (PCs), game systems, automotive and avionics displays, digital picture frames, TVs, set top boxes, digital video and still cameras, smart office and home appliances and lab or industrial devices equipped with displays and/or audio/visual capabilities, etc.

### SUMMARY OF THE INVENTION

Embodiments of the present invention create a “datapod” by associating a media object with a data object or objects so that a synchronized relationship between the media and data objects is formed and preserved. Thus, the Datapod™ can be shared or communicated which will intrinsically maintain the synchronized relationship between or among the media and data objects. Therefore, the files will play in the intended sequence and with the intended information conveyed precisely as the sender intended. For example, if a sender intends to take a photo and annotates the photo with a voice audio recording and then sends the photo and voice annotation to a recipient, the Datapod™ will play with the correct synchronization between the photo and the audio annotation as if the recipient were sitting next to the sender and seeing the same photo and listening to the audio annotation as it was made by the sender. In one embodiment of the present invention, the invention permits the user to play the Datapod™ by receiving a Datapod™, unpacking the Datapod™ into its synchronously associated media object and data object and playing the Datapod™ such that the synchronous association between the media object and the data object are maintained and the playing of the media object and data object is synchronized.

Embodiments of the present invention are achieved in a user friendly manner such that senders using a mobile device such as a mobile phone or a tablet computer or a digital camera equipped with the technology can easily create Datapods™ and the synchronized media association is intrinsically preserved on any device playing the associated media. Alternatively, any other device may be used to create or play the Datapod™, for example other mobile devices, personal computers (PCs), game systems, automotive and avionics displays, digital picture frames, TVs, set top boxes, digital video and still cameras, smart office and home appliances and lab or industrial devices equipped with displays and audio/visual capabilities, wearable computers, etc.

Other objects and attainments together with a fuller understanding of the invention will become apparent and appreciated by referring to the following description and claims taken in conjunction with the accompanying drawings.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a flowchart of a process to create a synchronized media association or Datapod™, in accordance with various aspects of the present invention.

FIG. 2 shows a functional block diagram of a device for creating a Datapod™ in accordance with various aspects of the present invention.

FIG. 3 shows a typical user interface for creating and sharing a Datapod™, in accordance with various aspects of the present invention.

FIG. 4 shows an embodiment of a user interface for creating a Datapod™, in which a media object (a photo of a crowd) is acquired, in accordance with various aspects of the present invention.

FIG. 5 shows an embodiment of a user interface for creating a Datapod™, in which a media object (an image of four geometric shapes) undergoes user navigation to create a Datapod™ that contains the media object and navigation, in accordance with various aspects of the present invention.

FIG. 6 shows an embodiment of a user interface for creating a Datapod™, in which a media object (a photo of a crowd) undergoes navigation including zooming, markup with pen and voice audio annotation to create a Datapod™, in accordance with various aspects of the present invention.

FIG. 7 shows an embodiment for creating a Datapod™ using two media objects with narration, in accordance with various aspects of the present invention.

FIG. 8 shows an embodiment for creating a Datapod™ using two media objects with pen and narration, in accordance with various aspects of the present invention.

FIG. 9 shows an embodiment for creating a Datapod™ using two media objects with navigation and narration, in accordance with various aspects of the present invention.

FIG. 10 shows a flowchart of a process to play a Datapod™, in accordance with various aspects of the present invention.

FIG. 11 shows a functional block diagram of a device for playing a Datapod™ in accordance with various aspects of the present invention.

FIG. 12 shows a user interface for playing a Datapod™ with a base media object, video and text annotation data objects, in accordance with various aspects of the present invention.

FIG. 13 shows an embodiment of a user interface for playing a Datapod™ with a base media object (a photo) with navigation including zooming and markup with pen, along with voice audio annotation, in accordance with various aspects of the present invention.

FIG. 14 shows a block diagram illustrating the relationship between creating and playing a Datapod™.

### DETAILED DESCRIPTION OF THE PREFERRED EMBODIMENTS

The following description is set forth for purpose of explanation in order to provide an understanding of the invention. However, it is apparent that one skilled in the art will recognize that embodiments of the present invention, some of which are described below, may be incorporated into a number of different computing systems and devices. The embodiments of the present invention may be present in hardware, software or firmware. Structures shown in the associated figures are illustrative of exemplary embodiments of the invention and are meant to avoid obscuring the invention. Furthermore, connections between components within the figures are not intended to be limited to direct connections. Rather, data between these components may be modified, re-formatted or otherwise changed by intermediary components.

Reference in the specification to “one embodiment”, “in one embodiment” or “an embodiment” etc. means that a particular feature, structure, characteristic, or function described in connection with the embodiment is included in at least one embodiment of the invention. The appearances of the phrase “in one embodiment” in various places in the specification are not necessarily all referring to the same embodiment.

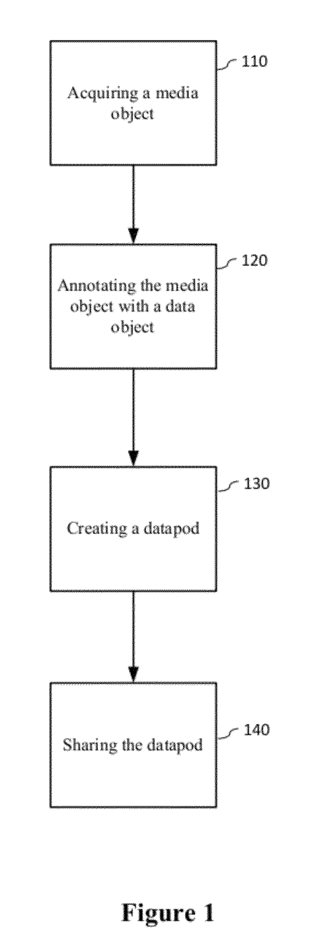

FIG. 1 is flowchart illustrating a process for creating a Datapod™ according to an embodiment of the present invention. FIG. 1 shows acquiring a media object 110. This acquisition can be performed using a camera, for example a digital camera or acquisition may be performed by using a digital camera in a mobile phone or tablet computer. The acquisition can also be performed using another device such as a security or traffic camera, other mobile devices, TVs, PCs, Game Systems, Automotive Displays or other devices equipped with digital still or video cameras and/or audio/video capabilities, etc. The acquiring 110 can also be accomplished by uploading a photo or image already stored on the device or from a networked file storage or the internet. In one embodiment, a user takes a picture using the camera built in to a mobile device, which becomes the media object. In one embodiment the media object is edited after it is acquired. Editing is accomplished using known digital image editing techniques.

Alternatively, the media object may be another type of file. One of ordinary skill in the art will recognize that any media object can be used. In some embodiments, the media object will be a media file such as a photo, image, text file, document, e.g., word document, pdf, excel, three dimensional (3D) model or file, Visio or other format, audio file or video file. A 3D model or file includes an object, a 3D terrain map, virtual world, synthetic environment, etc. In another embodiment, the media object is a collection of files rather than a single file.

Additional information may be stored along with the acquired media object. This additional information may be related to the date and time of media object capture, creation or editing or an event time, geo-location information associated with the media object, persons or events related to the media object, or other classification of the media object.

FIG. 1 also shows annotating the media object with a data object 120. This data object 120 can take the form of an audio recording, text or other data or media object. In one embodiment, a voice to text program could be used to create a text data object. In another embodiment, sign language could be used or a sign language to text program. Further a translation program could be used to translate from one language to another in audio or text. The data object can also take the form of an action, for example, navigation information. In one embodiment, the navigation information is panning around the image and/or zooming in on a particular part of the media object. In another embodiment, the navigation information is entered using a digital pen via touchscreen, stylus or other method to circle or highlight a particular portion of the media object for emphasis. In another embodiment, the navigation information is imparted by moving the device or by shaking or gesturing where device capabilities such as accelerometers may be used to record the movement. The navigation information can be input by a user or by the device itself, for example in the case of an automatic zoom feature. Navigation can be accomplished in a number of ways including using a touch screen, buttons, zooming, writing, highlighting, gesturing, voice command or mind control. In another embodiment, there are a plurality of data objects that can use all or some of the various examples of data objects.

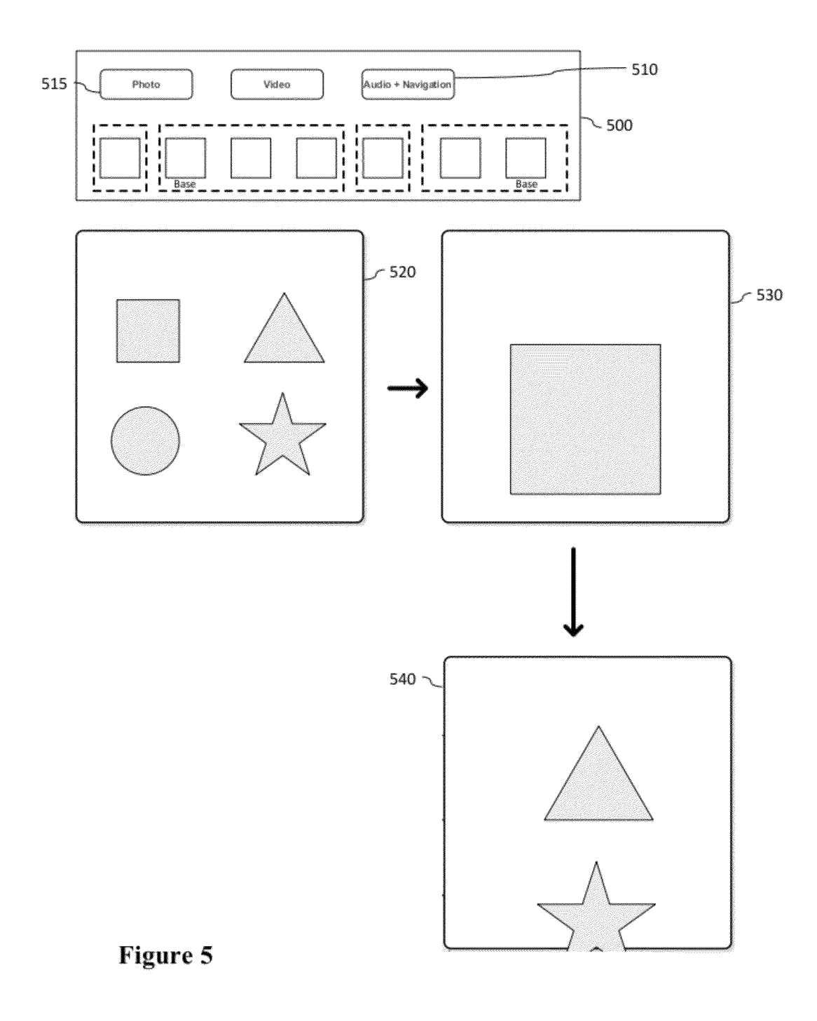

In one embodiment, the media object acquired is a photo of a child's artwork and the data object is an audio recording of the child describing the artwork. In another embodiment, there is more than one annotation to the acquired media object. In another embodiment, the media object is a video of a child's artwork. In some embodiments there is additional information stored with the acquired media object or the annotation such as date information, place information such as where the artwork was created, or information about the acquired media object or navigation information. Navigation information is discussed below with reference to FIGS. 5, 6, and 7.

FIG. 1 also shows creating a Datapod™ 130. In one embodiment the Datapod™ is a media file, such as a video file that may be readily shared and played on other devices. In other embodiments, the Datapod™ is a collection of media files along with essential association information such that the relationship including synchronization between the media object and the data object is preserved.

In the example where the media object is the photo of the child's artwork and the data object is the child's audio recording, the resulting Datapod™ can be a video file constructed by synchronously combining the audio portion of the child's voice simultaneously with displaying the child's artwork. Alternatively, the Datapod™ can be the collection of the media object and the data object along with the synchronized relationship of the objects such that they would play in the proper sequence, synchronization, and with the proper information.

FIG. 1 also shows sharing the Datapod™ 140. This sharing can be accomplished by the user sending the Datapod™ as an attachment in a text message, email, instant message, via a link to a website where the media object is stored and “streamed” such as YouTube® for video implementations of the Datapod™. The sharing can be also be accomplished by using a social media site for sharing such as Facebook®, Google+®, Drop Box® or Pinterest®. The sharing can also be accomplished using a removal drive, for example a universal serial bus (USB) drive or memory stick. It can also be accomplished using network drives or cloud drives. The sharing can also be accomplished using web based streaming.

One benefit of the present invention is the ease at which information can be shared. Currently, it is difficult to share information, particularly with multiple media file types. For example, it is challenging to share a video and a photo and have the two synchronized in such a way so that the recipient of the shared files has the same experience as if he were sitting next to the sender.

Another benefit of the present invention is that each of the steps depicted in FIG. 1 can be conducted in real-time and at the time the media object is acquired to enable real-time sharing or collaboration. Yet another benefit is that each of the steps depicted in FIG. 1 can be achieved on a mobile device in a user friendly fashion without knowledge of computers or programming, presentation preparation, non-linear video editing or other complex operations. The steps in FIG. 1 can be accomplished as easily as taking a photo with a camera phone.

The process shown in FIG. 1 has many applications. One application is in maintaining a collection of children's artwork. Many parents are busy and amass a large collection of their children's artwork, school projects, sports pictures and memorabilia, etc. Using the process shown in FIG. 1, a parent can take a photo of the each item in their collection, annotate the photo with voice, text, video, and/or other actions including navigation and form a synchronous association of the photo and the annotation. Additional information pertinent to the organization of the photo could also be maintained such as the date, the child's name, the child's grade, the subject of the photo, etc. This additional information can also form part of the Datapod™ so that this amplifying information could be used as a search string, shared with recipients or otherwise used in the future.

Advantageously, the parent could take a photo of their child's artwork as the child is picked up at school and in real-time the child could annotate the photo, or describe the artwork, and the association would be formed between the photo and the annotation. Additionally, in one embodiment other information is captured automatically or manually in real-time as well, such as the date and the location.

Within a matter of seconds or minutes the artwork is preserved and annotated and stored in such a way that it can be shared easily with others. Also, it is stored in such a way that it can be used in conjunction with other such Datapods™ to create an interactive or video based scrap book that may be shared with family and friends on a wide variety of devices including other mobile devices, personal computers (PCs), game systems, automotive and avionics displays, digital picture frames, TVs, set top boxes, digital video and still cameras, smart office and home appliances and lab or industrial devices equipped with displays and audio/visual capabilities, etc.

Another application to the process shown in FIG. 1 is to inventory items. There are number of reasons inventories are used, such as, for sale using the internet using Craigslist™ or EBay®, to give away to family or for the purpose of a will, for keeping track of items, for communicating a particular item for purchase. Using the process of FIG. 1 photos of items to be put up for sale can be acquired. A video, audio, text description of the items, and/or additional annotation action including navigation and/or markup using pen used to annotate the photo may also be conducted. The resulting Datapod™ can be shared via text, email, internet, etc. and may be dispatched automatically to websites such as Craigslist™ or EBay® to ease the process of selling the item(s). A similar process can be used to inventory for the purpose of giving away items or for recording the information for innumerous corporate (e.g., business inventor), professional (e.g., dental supply inventory), governmental (e.g., emergency supply inventory) or consumer purposes (e.g., home owner's inventory). The annotated inventory could also be transcribed to provide a legal, written copy of the inventory as well.

Additional applications of the process of FIG. 1 will be apparent to one of skill in the art. For example, there are many business applications. In many businesses expense reports are generated or receipts and other information are maintained for tax purposes. The receipts and other items are acquired in a photo image, annotated with video, voice, text, and/or an action and associated to be shared with an accountant or person in charge of expense processing or maintaining the books. The Datapod™ may also be readily transcribed into a document form for storage or legal purposes. There are also applications in the legal and medical professions for maintaining and organizing evidence for trial and for telemedicine applications and for maintaining and organizing patient files. Other applications that readily come to mind include virtually any avocation or profession where the sharing of annotated media objects is important—such as stamp collecting, teaching, law enforcement, industrial and fashion design, manufacturing quality assurance, scientific collaboration, geneology, etc. In each of these cases, the datapod's™ ready support for transcription with precise clarity provides significant benefit to the users. One of ordinary skill in the art will recognize that other applications not specifically described herein are also applicable.

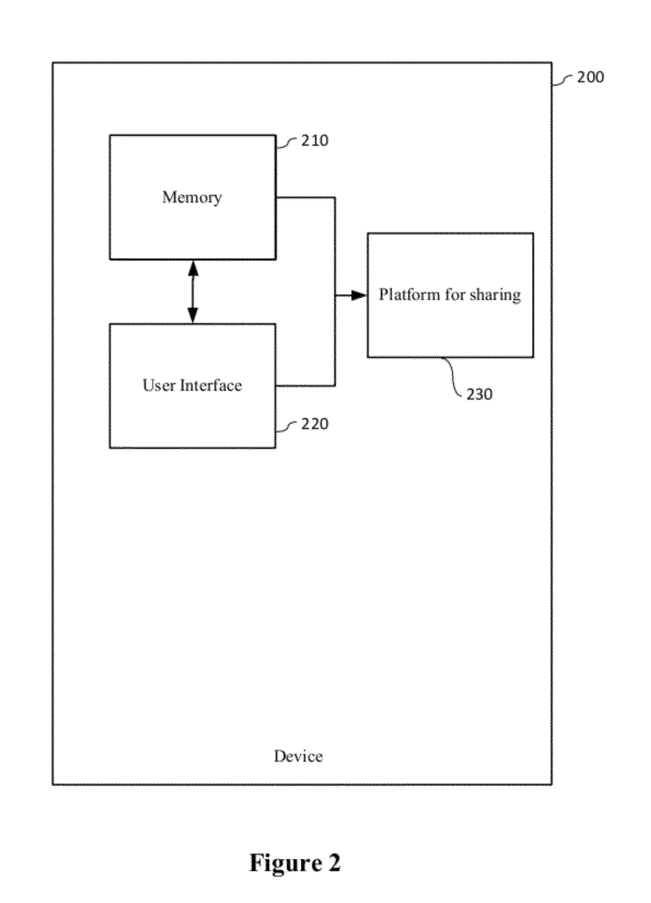

FIG. 2 shows a block diagram of a system in accordance with an embodiment of the present invention. FIG. 2 shows device 200 which may be used to create and share Datapods™. In one embodiment, device 200 is a mobile phone, for example an iPhone® made by Apple® or any other type of smartphone. In another embodiment, device 200 is a tablet computer, for example an iPad® made by Apple® or any other tablet computer. In another embodiment, device 200 is any type of computing device such as other mobile devices, personal computers (PCs), game systems, automotive and avionics displays, digital picture frames, TVs, set top boxes, digital video and still cameras, smart office and home appliances and lab or industrial devices equipped with displays and audio/visual capabilities, wearable computers, etc. The particular operating system running of the mobile device 200 is not critical to the present invention. The present invention works in conjunction with Apple® operating systems, Android® operating system by Google®, Windows® operating systems by Microsoft® or any other operating system. The present invention also works when instantiated in an application specific integrated circuit (ASIC) or field programmable gate array (FPGA) such that no operating system is required, which enables it to be deeply embedded in devices such as digital video and still cameras, office appliances, etc.

Device 200 houses memory 210. Memory 210 stores at least some portion of the acquired media object 110, data object 120 (annotation), and the Datapod™ 130. Further memory components may be used in conjunction with memory 210 (not shown). Those memory components can be stored on a different system and/or at a different location such as in a networked device or PC or in a cloud server.

Device 200 also has a user interface 220. The user interface 220 is used for acquiring media object 110 and annotating the media object with a data object 120. User interface 220 provides a user friendly means to interact with device 200. User interface 220 includes display, video, audio, and input device such as a touch screen, keyboard, stylus, gesture recognition, etc.

Device 200 also has a platform for sharing 230. The user interface 220 is used to interface with the platform for sharing 230 to share the Datapod™ 140. As discussed above with reference to FIG. 1, in one embodiment the platform for sharing is an email or text message. In another embodiment, the platform for sharing may be via a wired or wireless local area network or interface such as Ethernet, high definition multi-media interface (HDMI), Display Port, Thunderbolt®, wireless (WiFi), Bluetooth, universal serial bus (USB) or Zigbee, etc., In another embodiment, the platform for sharing may be via removable media such as USB “Stick”, Memory Card, subscriber identity module (SIM) Card, compact disc (CD) or digital video disc (DVD) or other such devices. In another embodiment the platform for sharing is a private or public media or social media site for sharing such as Facebook®, Google+®, Pinterest® or YouTube®.

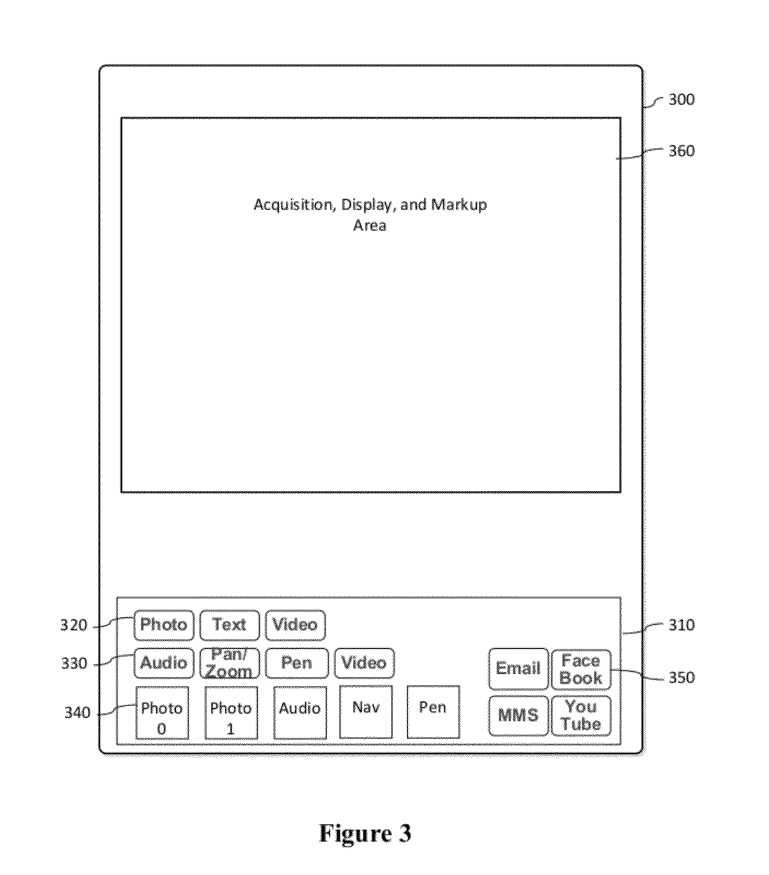

FIG. 3 shows a typical user interface for creating a Datapod™ as might be found on a mobile device. The user interface of FIG. 3 shows five areas of the screen, a primary display area for acquisition, display, navigation and markup 360, an area with real or touchscreen buttons related to acquiring a media object 320, an area related to creating an annotation data object 330, an area where Datapod™ contents can be implicitly associated 330, and an area where Datapods™ can readily be shared 350 via email, text or web.

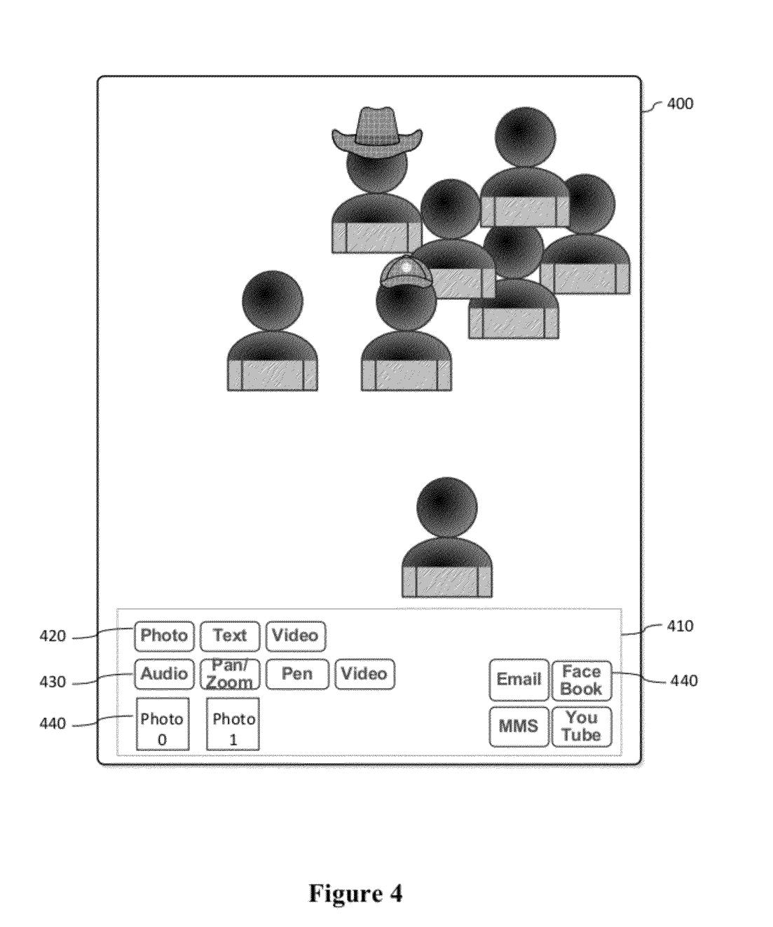

FIG. 4 shows an embodiment of a user interface for creating a Datapod™ in accordance with various aspects of the present invention. FIG. 4 shows FIG. 3 with the addition of a media object, a photo in this case, in the acquisition area. The user uses media acquisition buttons 420 to acquire or upload a media object. In this example, the user has acquired or uploaded a photo that contains images of a crowd with various people.

FIG. 5 shows an embodiment of a user interface demonstrating navigation information, in accordance with various aspects of the present invention. FIG. 5 illustrates the usefulness of capturing navigation information from a touch screen, cursor buttons, gestures or other input mechanism while displaying the image of geometric shapes on the small screen of a mobile device to annotate the image. FIG. 5 shows device screen 500 and select acquisition media type buttons 515. One of the select acquisition media type buttons is audio+navigation button 510.

A user who wants to annotate a media object with audio and also capture navigation information would use audio+navigation button 510. Once audio+navigation button 510 is selected the user can navigate through the media object 520 by panning left, right, up or down across the image and/or zooming into or out of a portion of the image, etc, all while narrating the actions. FIG. 5 shows media object 520 as a group of geometric shapes; however, the media object could be any media object, as described above. The user can then use the touch screen of the device, buttons on the device or other input mechanism (e.g., gestures) to expand or zoom in on a particular part of the image. The image shown in FIG. 5 shows the user zooming in on the square in the image 530. The user can then continue to narrate the audio while zooming on the square 530. The user can also perform other functions, for example, highlighting or circling a portion of the media object. While the user speaks and explains the media object, the user can move around the media object and navigate in or out of the media object. This navigation allows the user to identify something the user is talking about and see it clearly on the small screen. FIG. 5 also shows the user continuing to pan around and zoom on image 540. Again, this information is stored as part of the annotated information within the Datapod™

For another example, the media object could contain a spreadsheet, pdf or an image of a spreadsheet and the user wants to refer to a particular line item or cell on the spreadsheet, perhaps to highlight an important figure, calculation, result or error, etc. During the audio recording+navigation activity the user can zoom in on and highlight a particular line item on the spreadsheet while discussing it. That navigation information becomes part of the Datapod™. When the Datapod™ is shared with one or more recipient(s), the recipient(s) will see the image which will pan left, right, up and down and zoom in and out via the associated navigation information precisely as recorded by the user (sender) and will simultaneously hear the appropriate, synchronized audio recording. Thus allowing the sender and recipient to communicate as if sitting right next to each other.

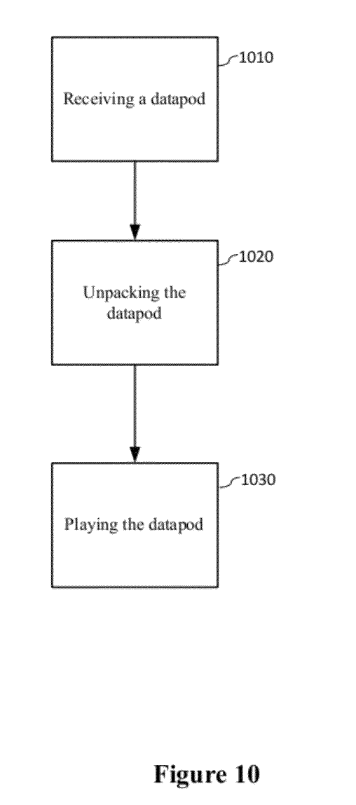

In one embodiment, the Datapod™ itself is shared with one or more recipients. The recipients then can use a Datapod™ player to play the Datapod™ as discussed below in reference to FIGS. 10-14. In another embodiment, the Datapod™ is converted to a video and the video is shared with one or more recipients.

In another example, the media object could contain a child's artwork. The annotation data object could be the child's voice while he describes different portions of the art. As he is describing the art he can pan to that portion and zoom in on it. The annotated media object, the image of the artwork along with the navigation information and the audio forms the Datapod™. The Datapod™ can be shared with a recipient, for example, the child's grandparent. The grandparent would see the media object complete with navigation and hear the child's voice as if the grandparent were sitting beside the child describing the artwork.

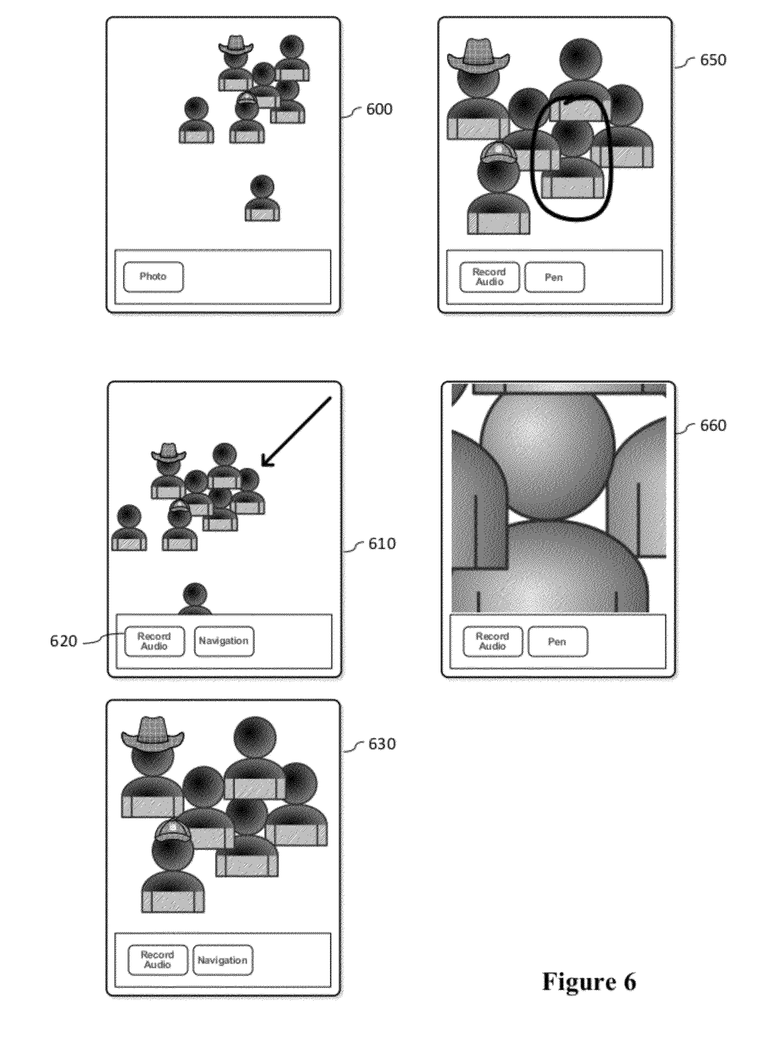

FIG. 6 shows an embodiment of a user interface for creating a Datapod™ in accordance with various aspects of the present invention. FIG. 6 is another example of using the audio+navigation function shown in FIG. 5. The embodiment shown in FIG. 6 continues with the example of the media object shown in FIG. 4. FIG. 4 shows screen 600, including an acquisition area with a photo of a crowd of people that has been uploaded or acquired. While FIG. 6 shows a photo as the media object, the media object could be a video or any other media object described above. In the embodiment shown in FIG. 6, the user (sender) is looking for a particular person in the crowd. The user (sender) takes a photo using a mobile device and puts that photo on screen 600. The user (sender) would like to indicate a specific person in the crowd so the photo is annotated using navigation button 620 and then by moving the person into the center of the screen 610 using the touch screen, physical buttons, voice command or other input method.

The user (sender) then continues to annotate by zooming in to make it easier to identify the face of the person 630. In one embodiment, as the user (sender) zooms in he can also be recording audio, for example, “I think this is the person we are looking for. I am going to zoom in further to see.” In one embodiment, the user (sender) can also use a pen to annotate the media object 640. The user (sender) can also continue to record audio, for example, “Yes, this is the one we are looking for. See his face here.” In one embodiment, the user can continue to zoom in 650. The user can also continue to record audio, for example, “Look at that scarf. It has the logo we are interested in finding.”

In each scenario described above, the audio recording and the navigation, including panning, zooming and marking actions are properly synchronized in the resulting Datapod™. The ability to pan, zoom and mark provides ease of communication when communicating to someone who is not co-located with the sender. Also when combined together or combined with audio recording (or other data object annotation) the resulting collection of annotated media objects becomes an extremely powerful communications capability due to the ability of the Datapod™ to have the media object and one or more data objects appropriately synchronized. Although not depicted in FIG. 6, the concept of FIG. 6 could also be applied to multiple media objects. For example different media objects could be compared or contrasted along with their associated annotated data objects.

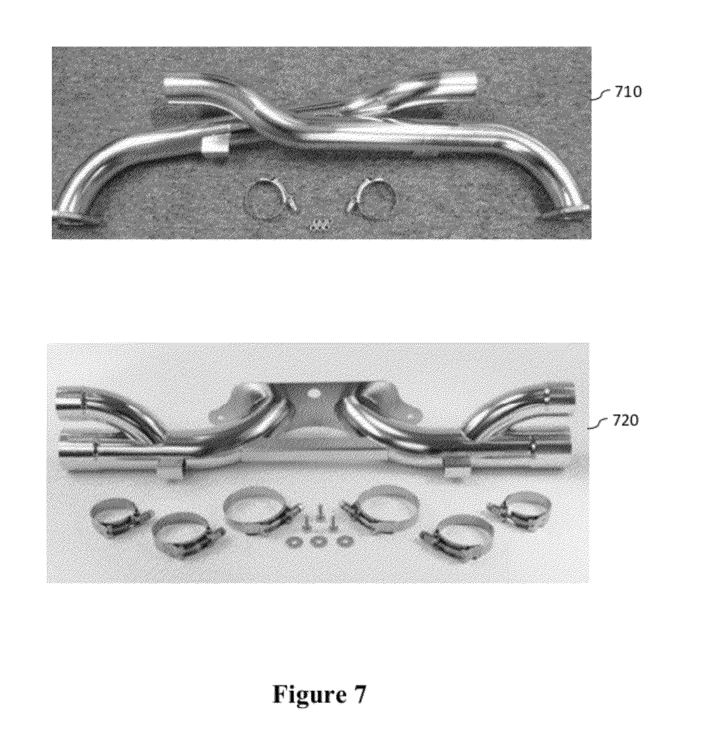

FIG. 7 shows an embodiment of a user interface for creating a Datapod™ using two media objects with narration, in accordance with various aspects of the present invention. FIG. 7 provides an example of a using two images as media objects and using narration as the data object. In the embodiment shown in FIG. 7 the image used is of automotive parts. As discussed above, any media object could be used. In the embodiment shown in FIG. 7 a first image is loaded as a media object 710. The user interface shown in FIG. 3 is used to load the image and to record the data object. In this example, the data object is a voice audio recording, “The design features are different in two significant ways. The 997 Bypass replaces the primary muffler and is a crossover design, meaning the left header feeds the right secondary muffler and vice versa.”

Using user interface shown in FIG. 3, a second media object is loaded. In the embodiment shown in FIG. 7, the second media object is another image of automotive parts 720. Also using user interface show in FIG. 3, another data object audio recording is recorded, “Unlike the 997 Bypass, the GT3 Bypass is installed after the primary mufflers, replacing the single combined secondary muffler. Exhaust gas is redirected through independent air tubes to the centrally located external exhaust tips.” In the embodiment shown in FIG. 7, the Datapod™ includes two media objects, the two photos 710 and 720 and two data objects, the two voice recordings. The Datapod™ can be shared with one or more recipients using the methods described above. Using the Datapod™ to compare or contrast two or more annotated media objects can be an extraordinarily powerful communication tool.

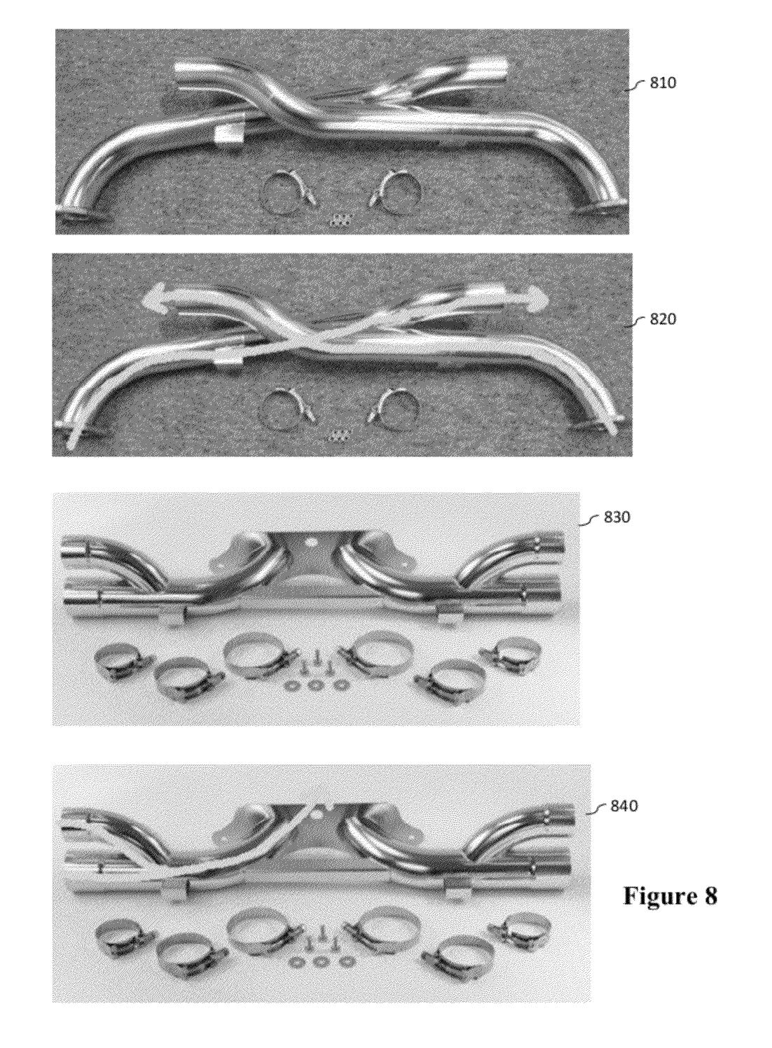

FIG. 8 shows an embodiment of a user interface for creating a Datapod™ using two media objects with pen for markup and narration, in accordance with various aspects of the present invention. The embodiment shown in FIG. 8 uses the user interface shown in FIG. 3 to compare two media objects using pen and narration. The use of two media objects allows a user to compare and contrast the media objects while maintaining the appropriate synchronization of the data objects and media objects.

FIG. 8 shows first media object 810 which can be loaded using the user interface show in FIG. 3. The user can also use the user interface shown in FIG. 3 to mark up the media object 820 using the pen. In this example, the markup shows the crossover of exhaust gas flow. The user can also use the user interface shown in FIG. 3 to record an audio recording, for example, “The design features are different in two significant ways. The 997 Bypass replaces the primary muffler and is a crossover design, meaning the left header feeds the right secondary muffler and vice versa, while the GT3 Bypass employs the primary muffler and uses a central exhaust approach.”

The user can use the user interface shown in FIG. 3 to load a second media object 830 and create a markup of the media object 840. The user interface of FIG. 3 can also be used to record an audio recording, for example, “The GT3 Bypass is installed after the primary mufflers, replacing the single combined secondary muffler. Exhaust gas is redirected through independent air tubes to the centrally located external exhaust tips.” The Datapod™ can be shared with one or more recipients using the methods described above. Using the Datapod™ to compare two or more annotated media objects can be an extraordinarily powerful communication tool.

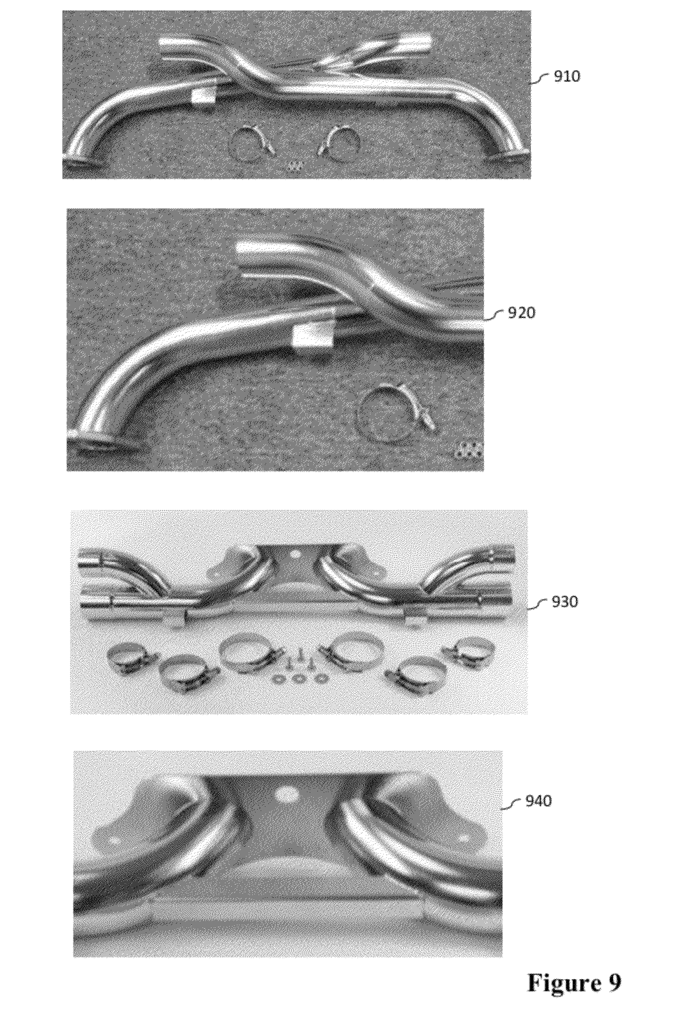

FIG. 9 shows an embodiment of a user interface for creating a Datapod™ using two media objects with navigation and narration, in accordance with various aspects of the present invention. The embodiment shown in FIG. 9 uses the user interface shown in FIG. 3 to compare two media objects using navigation and narration. The use of two media objects allows a user to compare and contrast the media objects while maintaining the appropriate synchronization of the data objects and media objects.

FIG. 9 shows first media object 910 which can be loaded using the user interface show in FIG. 3. The user can also use the user interface shown in FIG. 3 to pan around and zoom in on the media object 920. In this example, the zoom in shows the crossover of exhaust gas flow. The user can also use the user interface shown in FIG. 3 to record an audio recording, for example, “The design features are different in two significant ways. The 997 Bypass replaces the primary muffler and is a crossover design, meaning the left header feeds the right secondary muffler and vice versa.”

The user can use the user interface shown in FIG. 3 to load a second media object 930 and zoom in on the media object 940. The user interface of FIG. 3 can also be used to record an audio recording, for example, “The GT3 Bypass is installed after the primary mufflers, replacing the single combined secondary muffler. Exhaust gas is redirected through independent air tubes to the centrally located external exhaust tips.” The Datapod™ can be shared with one or more recipients using the methods described above. Using the Datapod™ to compare two or more annotated media objects can be an extraordinarily powerful communication tool.

As described above, a Datapod™ can be sent as a Datapod™ or as a video. If it is sent as a video file, there is no need for a Datapod™ player to play the video. Any video player can be used to play the video file. However, it can be more efficient to send the Datapod™ as a Datapod™ rather than a video file. A Datapod™ can be smaller than an equivalent video file, requiring less space to store and less bandwidth to send, since it does not need to include resulting video frames, since, depending on the media objects, may only require images and data objects including navigation information and audio files, which collectively may be much smaller than a video with the 24, 30 or 60 frames of video per second typically required for smooth playback. In the example in FIG. 9, the Datapod™ would only include the two (2) still images, the navigation information (pan and zoom) and the audio annotation. Assuming the resulting Datapod™ in FIG. 9 was 1 minute long in duration, the video version of the Datapod™, if constructed at the same resolution as the base image, could be as much as 30 times larger than the Datapod™ itself. In the event where bandwidth or storage is at a premium, it could therefore be very advantageous to send the Datapod™ as a Datapod™

Furthermore, the Datapod™ preserves the fidelity of the original media objects and data objects since it does not require the same compression levels needed for video transmission and storage. In addition, sending Datapods™ in lieu of video may also preserve scarce computing resources and battery power on mobile and other computing devices. Encoding video is a time and compute intensive process, such that creating a 1 minute video on some devices may take substantially longer than 1 minute. However, since the Datapod™ is created at the time navigation, narration, etc., the resulting compute resources and battery power required to simply package the Datapod™ for transmission is substantially less, thereby saving compute resources and preserving battery life. Transmitting Datapods™ also enables real-time collaboration since it is possible to communicate navigation information to a recipient who can follow along with a live annotation. When sent as a Datapod™, a Datapod™ player is required to play the Datapod™ appropriately.

FIG. 10 shows a flowchart of a process to play a Datapod™, in accordance with various aspects of the present invention. The Datapod™ player receives the Datapod™ 1010. It then unpacks the Datapod™ 1020 into its component media objects and data objects. Finally, the Datapod™ player views the Datapod™ 1030 by playing the media and data objects maintaining the synchronization between the media and data objects.

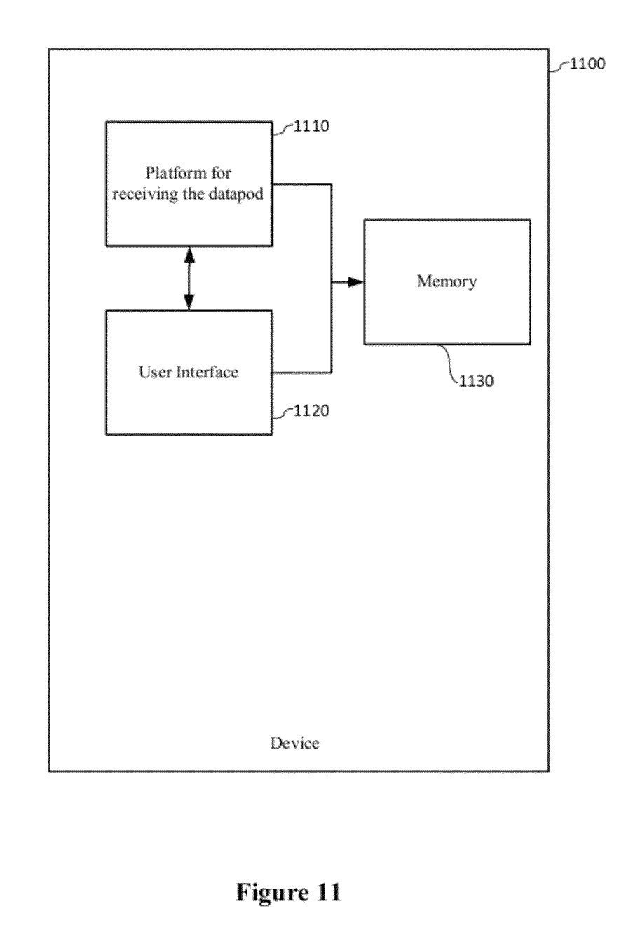

FIG. 11 shows a functional block diagram of a device for playing a Datapod™ in accordance with various aspects of the present invention. The Datapod™ player can reside on any type of computing device 1100. Device 1100 can be a mobile device or other platform including mobile devices, personal computers (PCs), game systems, automotive and avionics displays, digital picture frames, TVs, set top boxes, digital video and still cameras, smart office and home appliances and lab or industrial devices equipped with displays and audio/visual capabilities, wearable computers, etc. The Datapod™ player has a platform for receiving the Datapod™ 1100. That platform receives the Datapod™ and unpacks the Datapod™. The device 1100 also has a user interface 1120 including video screen and in some cases audio playback and user input capabilities for interfacing with its user (recipient). The device 1100 also has a memory 1130 for storing the Datapod™. Further memory components may be used in conjunction with memory 1130 (not shown). Those memory components can be stored at a different location, on a networked device or in a cloud server.

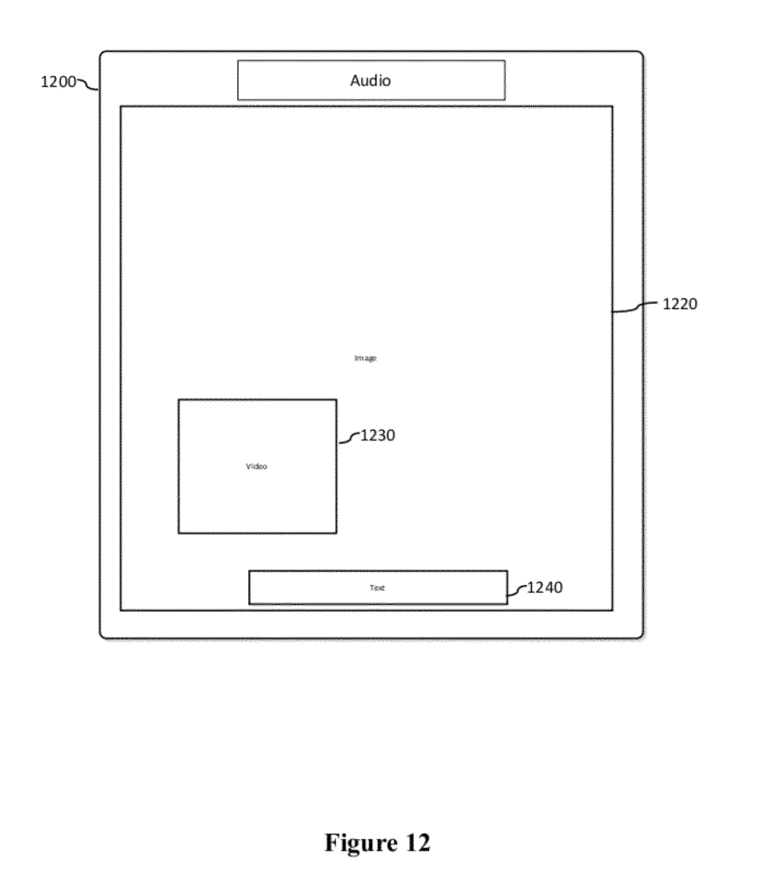

FIG. 12 shows a user interface for playing a Datapod™, in accordance with various aspects of the present invention. User interface 220 includes video, audio, and input device such as a touch screen, keyboard, or stylus. FIG. 12 shows screen 1200. Contained within screen 1200 are image area 1220, video area 1230, and text area 1240. The image area 1220 is an area of the screen 1200 dedicated to displaying images. Video area 1230 is an area of the screen 1200 dedicated to playing video. Text area 1240 is an area of the screen 1200 dedicated to displaying text. Screen 1200 can be user configurable to provide the various areas 1220, 1230 and 1240 in different locations on screen 1200 or different sizes. Alternatively, a plurality of screen areas of a particular type can also be provided. In addition, audio capabilities and user input areas may also be provided. Thus enabling the recipient to play the Datapod™ appropriately such that each media object and data object is shown and shown in the appropriate synchronization.

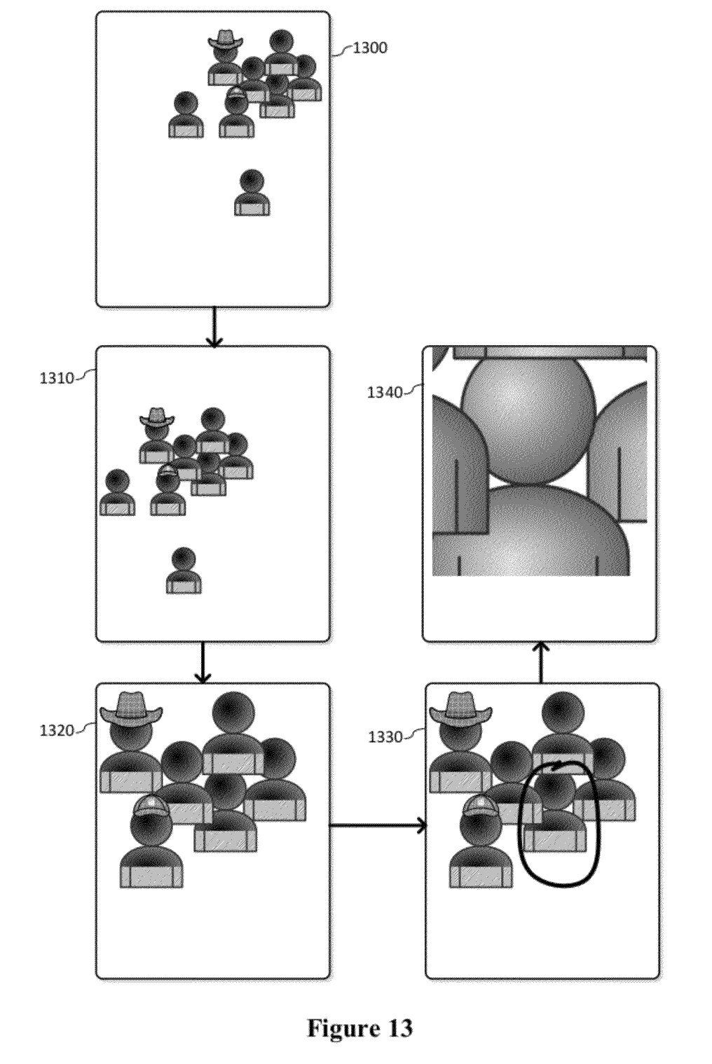

FIG. 13 shows an embodiment of a user interface for playing a Datapod™ in accordance with various aspects of the present invention. FIG. 13 illustrates how the example shown in FIG. 6 could be played using a Datapod™ player. The Datapod™ player can play the Datapod™ in the same way and with the same level of detail as when the Datapod™ was created. For example, as FIG. 13 illustrates the media object 1300 would be seen on the player followed by the panning 1310 then the zooming 1320, markup 1330, and further zooming 1340. Meanwhile at the appropriate times the synchronized audio recordings would also be played along with the images, panning, zooming, and marking, replicating with precise fidelity what the sender recorded. The recipient contemplated in FIG. 13 would therefore clearly understand the individual shown in 1340 was part of the crowd shown 1300 that was identified through the panning, zooming and marking process by the sender. If, for example, the individual shown in 1340 was a lost child at a sporting event, the Datapod™ could be dispatched to local officials and to the broadcast booth to inform the crowd about the lost child.

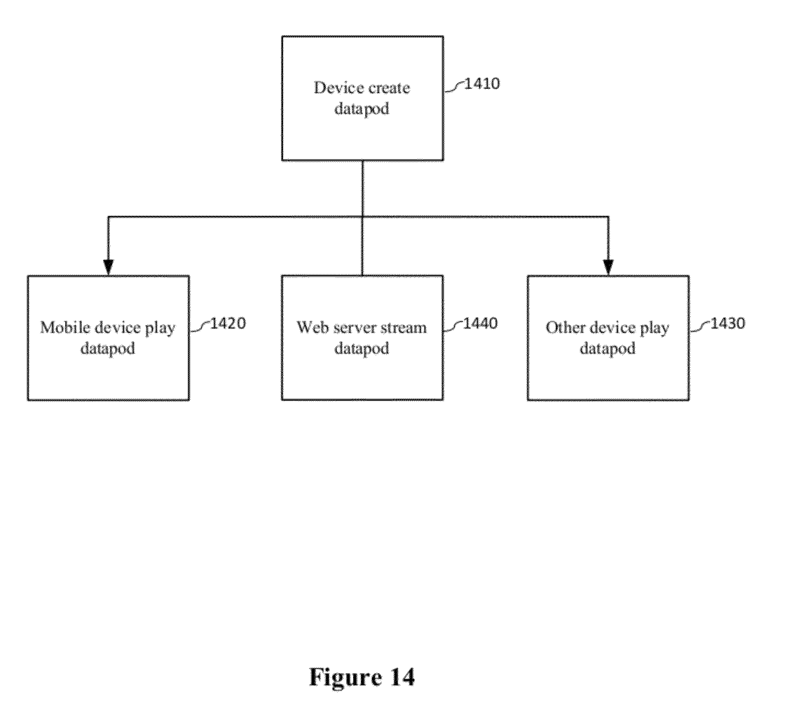

FIG. 14 shows a block diagram illustrating the relationship between creating and playing a Datapod™. FIG. 14 shows a device used to create a Datapod™ 1410. Since mobile devices can be carried anywhere one embodiment would use a mobile device to create the Datapod™. However, the Datapod™ could also be created on another type of device, such as other mobile devices, personal computers (PCs), game systems, automotive and avionics displays, digital picture frames, TVs, set top boxes, digital video and still cameras, smart office and home appliances and lab or industrial devices equipped with displays and audio/visual capabilities, wearable computers, etc. The mobile device can also be used to play the Datapod™ 1420. The mobile device used to play the Datapod™ can be the same mobile device used to create the Datapod™ or it can be another mobile device that received the Datapod™. FIG. 14 also shows another device used to play the Datapod™ 1430. The Datapod™ can be sent to a device other than a mobile device to be played, for example other mobile devices, TVs, PCs, Game Systems, Automotive Displays, etc. FIG. 14 also shows using a web server to stream the Datapod™ 1440. In one embodiment the Datapod™ can be shared by streaming via a web streaming service.

It will be apparent to one of ordinary skill in the art that the present invention can be implemented as a software application running on a mobile device such as a mobile phone or a tablet computer. It will be apparent to one of ordinary skill in the art that the present invention can be implemented as firmware in an field programmable gate array (FPGA) or as all or part of an application specific integrated circuit (ASIC) such that software is not required. It will also be apparent to one of ordinary skill in the art that computer readable media includes not only physical media such as compact disc read only memory (CD-ROMs), SIM cards or memory sticks but also electronically distributed media such as downloads or streams via the internet, wireless or wired local area networks or interfaces such as Ethernet, HDMI, Display Port, Thunderbolt®, USB, Bluetooth or Zigbee, etc., or mobile phone system.

While the invention has been described in conjunction with several specific embodiments, it is evident to those skilled in the art that many further alternatives, modifications and variations will be apparent in light of the foregoing description. Thus, the invention described herein is intended to embrace all such alternatives, modifications, applications, combinations, permutations, and variations as may fall within the spirit and scope of the appended claims.

What is claimed is:

1. A method for creating a datapod using a device, comprising:
acquiring a media object;
annotating the media object with a data object; and
creating a datapod by synchronously associating the media object and the data object such that a relationship between the media object and the data object is formed maintaining a synchronization between the media object and the data object.

2. The method of claim 1, wherein the data object is a media object.

3. The method of claim 1, wherein the data object is an action.

4. The method of claim 3, wherein the action is a navigation action.

5. The method of claim 3, wherein the data object is a markup using pen.

6. The method of claim 3, wherein the action is a motion.

7. The method of claim 3, wherein the action is a gesture.

8. The method of claim 1, wherein the device has a touchscreen.

9. The method of claim 1, wherein the device is a handheld device.

10. The method of claim 9, wherein the device is a mobile phone.

11. The method of claim 9, wherein the device is a tablet computer.

12. The method of claim 1, further comprising sharing the datapod.

13. The method of claim 12, wherein the sharing is performed by sharing the datapod.

14. The method of claim 12, wherein the sharing is performed by converting the datapod into a video file and sharing the video file.

15. The method of claim 12, wherein the sharing the datapod is performed using a media sharing platform.

16. The method of claim 12, wherein the datapod is created at the same time as at least one of the media object and data object is acquired.

17. The method of claim 1 further comprising editing the media object.

18. The method of claim 1, wherein the media object is a plurality of media objects such that the media objects can be compared to each other.

19. A system for creating a datapod comprising:
a memory for storing a media object and a data object;
a user interface for creating a datapod by associating the media object and the data object at the time that at least one of the media object and data object is acquired; and
a platform for sharing the datapod.

20. The system of claim 19, wherein the data object is a media object.

21. The system of claim 19, wherein the data object is an action.

22. The system of claim 21, wherein the action is a navigation action.

23. The system of claim 21, wherein the action is a motion.

24. The system of claim 19, wherein the system has a touchscreen.

25. The system of claim 19, wherein the system is a handheld device.

26. The system of claim 25, wherein the system is a mobile phone.

27. The system of claim 25, wherein the system is a tablet computer.

28. The system of claim 19, wherein the platform for sharing the datapod shares the datapod.

29. The system of claim 19, wherein the platform for sharing the datapod converts the datapod into a video file and shares the video file.

30. Computer readable media for creating a datapod using a device, comprising computer readable code recorded thereon for:
acquiring a media object;
annotating the media object with a data object; and
creating a datapod by associating the media object and the data object such that a synchronized relationship between the media object and the data object is formed.
